(19) United States
(12) Patent Application Publication
(10) Pub. No.: US 2024/0144254 A1
(43) Pub. Date: May 2, 2024

(54) FINANCIAL TRANSACTION SYSTEM USING INDIVIDUAL DISTRIBUTION KEYS BASED ON MULTI-PARTY COMPUTATION AND METHOD THEREOF

(71) Applicant: HiFiveLab Inc., Seoul (KR)

(72) Inventors: Gi Hoon KANG, Yongin-si (KR); Min Suk KIM, Seoul (KR); Young Seop SHIN, Seongnam-si (KR)

(73) Assignee: HiFiveLab Inc., Seoul (KR)

(21) Appl. No.: 18/318,885

(22) Filed: May 17, 2023

(30) Foreign Application Priority Data
Oct. 26, 2022 (KR) 10-2022-0139184

(51) Int. Cl. G06Q 20/38

(52) U.S. Cl. CPC G06Q 20/3823; G06Q 20/3825; G06Q 20/3829

(57) ABSTRACT

The present disclosure relates to a financial transaction system using individual distribution keys based on multi-party computation. The financial transaction system includes at least: a private key pieces generation unit dividing an individual private key corresponding to a user and generating private key pieces; an individual distribution key generation unit generating the individual distribution key corresponding to the user by using some of individual private key pieces shared with one or more other users and some of the plurality generated individual private key pieces; and a signature unit signing with the individual distribution key of the user, in which when a verification is performed by combining a signature value signed by the individual distribution key of the user and a signature value signed by individual distribution keys of one or more other users, the transaction is concluded between the users who sign.

### CROSS-REFERENCE TO RELATED APPLICATIONS

This application claims priority to and the benefit of Korean Patent Application No. 10-2022-0139184 filed in the Korean Intellectual Property Office on Oct. 26, 2022, the entire contents of which are incorporated herein by reference.

### TECHNICAL FIELD

The present invention relates to a financial transaction system using individual distribution keys based on multi-party computation, and more particularly, to a financial transaction system using individual distribution keys based on multi-party computation and a method thereof, which may perform a financial transaction with another user as a beneficiary only with signatures of some users without a need for participation of all users in order to execute a financial transaction between a plurality of users.

### BACKGROUND ART

A hardware security module (hereinafter, referred to as HSM) is a physical computing device specially manufactured for safe key storage and encryption processing. In short, the HSM is designed to protect key confidentiality. While a key is in a security hardware environment, a task can be performed by using the key.

For the purpose of cryptocurrency, the HSM is used to store private keys used for transaction signatures and validity check. The HSM can be connected to a network, but can be used to protect a wallet (also called ‘cold storage’) that is completely separated from the Internet in an offline mode.

Multi-Signature is a signature scheme in which a transaction occurs when multiple managers generate multiple keys in cryptocurrency wallets for the transaction and perform signature with multiple keys.

When a multi-signature technology is applied, multiple managers must participate in the transaction signature for a currency transaction. In other words, the transaction is made by signing multiple keys of multiple people. When a multi-signature scheme is used, even though one of multiple keys is hacked or lost, any transaction cannot be generated by using one key. Since the transaction is generated only when there are multiple signatures, the multiple signatures have recently emerged as a technology that can prevent the stealing of the cryptocurrency.

Multi-party computation (hereinafter, referred to as MPC) means that multiple parties who do not trust each other output a calculation result of an encrypted input value without sharing input values thereof. The MPC is a technology in which multiple participants prove identities or contents thereof without delivering sensitive information while safely participating a computation of a function while not knowing multiple input values.

Homomorphic encryption is an encryption technique that can perform the computation while encrypting data.

Zero-Knowledge Proof is an encryption system that can prove that a prover knows information for a verifier which is an opponent without disclosing secret information thereof.

On the other hand, in the related art, in order to execute the financial transactions between a plurality of users, there is an inconvenience that all the users had to participate. In other words, there is only a difficulty in which users who want to do financial transactions only have a transaction between users who undergo their own certification, and financial transactions for third parties cannot be made.

### SUMMARY OF THE INVENTION

Therefore, a first object to be solved by the present invention is to provide a financial transaction system using individual distribution keys based on multi-party computation, which may perform a financial transaction with another user as a beneficiary only with signatures of some users without a need for participation of all users in order to execute a financial transaction between a plurality of users.

A second object to be solved by the present invention is to provide a financial transaction method using individual distribution keys based on multi-party computation, which may prevent individual distribution keys from being exposed even though all user terminals are hacked by encrypting the individual distribution keys.

An object is to provide a computer-readable recording medium having a program for executing the method in a computer, which is recorded therein.

An exemplary embodiment of the present invention provides a financial transaction system using individual distribution keys based on multi-party computation, which includes: a private key pieces generation unit dividing an individual private key corresponding to a user and generating a plurality of private key pieces; an individual distribution key generation unit generating the individual distribution key corresponding to the user by using some of individual private key pieces shared with one or more other users and some of the plurality generated individual private key pieces; and a signature unit signing with the individual distribution key of the user, in which when a verification is performed by combining a signature value signed by the individual distribution key of the user and a signature value signed by individual distribution keys of one or more other users, the transaction is concluded between the users who sign.

According to an exemplary embodiment of the present invention, participates in generating the individual distribution key, and does not participate in signing the transaction among the one or more other users may be designated as a beneficiary of the transaction.

The financial transaction system may further include: a common public key generation unit generating a common public key based on the individual distribution keys of the one or more other users and the individual distribution key of the user; and a joint signature value derivation unit combining the signature value signed with the individual distribution key of the user and the signature value shared of the one or more other users to derive a joint signature value, and the derived joint signature value is verified by using the common public key to confirm of the validity of the transaction.

Another exemplary embodiment of the present invention provides a financial transaction method using individual distribution keys based on multi-party computation, which includes: dividing an individual private key corresponding to a user and generating a plurality of private key pieces; generating the individual distribution key corresponding to the user by using some of individual private key pieces shared with one or more other users and some of the plurality generated individual private key pieces; and signing with the individual distribution key of the user, in which a verification is performed by combining a signature value signed by the individual distribution key of the user and a signature value signed by individual distribution keys of one or more other users, the transaction is concluded between the users who sign.

According to an exemplary embodiment of the present invention, a user who participates in generating the individual distribution key, and does not participate in the transaction among the one or more other users may be designated as a beneficiary of the transaction.

The financial transaction method may further include: generating a common public key based on the individual distribution keys of the one or more other users and the individual distribution key of the user; and combining the signature value signed with the individual distribution key of the user and the signature value shared of the one or more other users to derive a joint signature value, and the derived joint signature value may be verified by using the common public key to confirm of the validity of the transaction.

Still another exemplary embodiment of the present invention provides a computer-readable recording medium having a program for executing the financial transaction method using individual distribution keys based on multi-party computation, which is recorded therein.

According to the present invention, it is possible to perform a financial transaction with another user as a beneficiary only with signatures of some users without a need for participation of all users in order to a financial transaction between a plurality of users.

According to the present invention, it is possible to a financial transaction method which may prevent individual distribution keys from being exposed even though all user terminals are hacked by encrypting the individual distribution keys.

### BRIEF DESCRIPTION OF THE DRAWINGS

FIG. 1 is an overall system configuration diagram including a multi-party computation based digital signature apparatus according to an exemplary embodiment of the present invention.

FIG. 2 is a diagram schematically illustrating a process of generating a common public key by sculpting individual private keys in a multi-party computation based digital signature method according to an exemplary embodiment of the present invention.

FIG. 3 is an overall system configuration diagram including a multi-party computation based digital signature apparatus according to another exemplary embodiment of the present invention.

FIG. 4 is a diagram schematically illustrating a process of signing using individual distributed keys according to another exemplary embodiment of the present invention.

FIG. 5 illustrates a process of signing using individual distributed key pieces stored for each user according to another exemplary embodiment of the present invention.

FIG. 6 illustrates a state in which a user does not have one private key, and the private key is divided into several individual distributed keys and distributed to a plurality of wallet servers included in a business system according to still another exemplary embodiment of the present invention.

FIG. 7 is a flowchart of a multi-party computation based digital signature method according to an exemplary embodiment of the present invention.

FIG. 8 is a flowchart of a multi-party computation based digital signature method according to another exemplary embodiment of the present invention.

FIG. 9 is a conceptual view of a financial transaction system using a multi-party computation based digital signature apparatus according to an exemplary embodiment of the present invention.

FIG. 10 is a flowchart of a financial transaction method using a multi-party computation based digital signature method according to an exemplary embodiment of the present invention.

### DETAILED DESCRIPTION

Hereinafter, exemplary embodiments of the present invention will be described in detail so as to be easily implemented by those skilled in the art, with reference to the accompanying drawings. However, the exemplary embodiments are intended to explain the present invention more specifically, and it will be apparent to those skilled in the art that the scope of the present invention is not limited thereto.

The configuration of the invention to clarify the solution of the problem to be solved by the present invention will be described in detail with reference to the accompanying drawings based on the preferred embodiment of the present invention, and it is revealed in advance that in giving reference numerals for components in the drawings, the same component is denoted by the same reference numeral even if the components are in different drawings, and when the description of the corresponding drawing is required, the component of the different drawing can be cited. Moreover, in specifically describing an operating principle for the preferred embodiment of the present invention, if it is judged that detailed description of a known function or configuration related to the present invention and other matters may make the gist of the present invention obscure, the detailed description is omitted.

Terms used in the present application are used only to describe specific exemplary embodiments, and are not intended to limit the present invention. A singular form may include a plural form if there is no clearly opposite meaning in the context. In the present application, it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

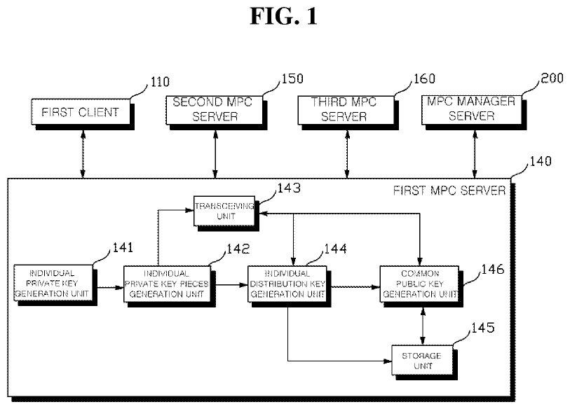

FIG. 1 is an overall system configuration diagram including a multi-party computation based digital signature apparatus according to an exemplary embodiment of the present invention.

Referring to FIG. 1, an entire system including the multi-party computation based digital signature apparatus is configured to include a first client 110, a first MPC server 140, a second MPC server 150, a third MPC server 160, and an MPC manager server 200.

The first MPC server 140 includes an individual private key generation unit 141, an individual private key pieces generation unit 142, a transceiving unit 143, an individual distribution key generation unit 144, a storage unit 145, and a common public key generation unit 146. In FIG. 1, a detailed configuration of the first MPC server 140 is illustrated, but the second MPC server 150 and the third MPC server 160 are also configured similarly, and the number of MPC servers is not limited to three.

The MPC manager server 200 confirms whether the first MPC server 140, the second MPC server 150, and the third MPC server 160 participate in generating the common public key, and requests generating the common public key. In addition, the MPC manager server 200 may request a signature participation to the first MPC server 140, the second MPC server 150, and the third MPC server 160 when a transaction signature is required.

The individual private key generation unit 141 generates an individual private key corresponding to a user. The individual private key may be randomly generated internally in the first MPC server 140. It is preferable that the individual private key is used for the first MPC server 140 to generate the individual private key pieces, and then not stored. Since the individual private key is not stored on each MPC server, and some of the individual private key pieces are shared between the MPC servers, it is difficult to fully recover the individual private keys even if any MPC server is hacked.

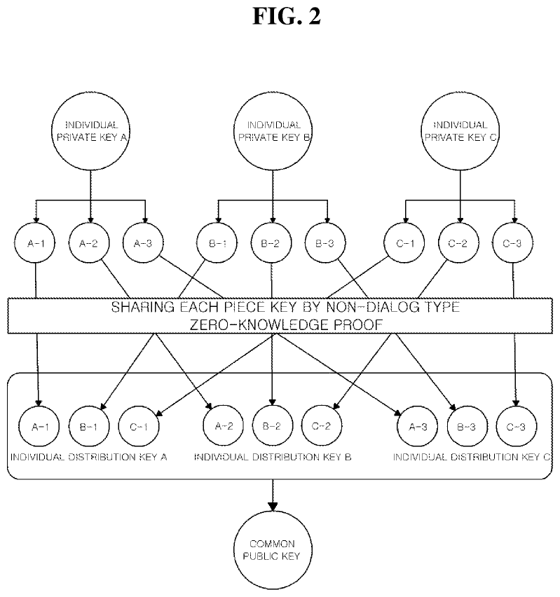

The individual private key pieces generation unit 142 divides the generated individual private keys and generates a plurality of individual private key pieces. Referring to FIG. 2, the individual private key A may be divided into A-1, A-2, and A-3, the individual private key B may be divided into B-1, B-2, and B-3, and the individual private key C may be divided into C-1, C-2, and C-3. In FIG. 2, the individual private key is divided into three pieces, but the number of pieces acquired by dividing the individual private key is not limited thereto. The number of users who participate in multi-party computation based digital signature according to an exemplary embodiment of the present invention may be set to the number of pieces acquired by dividing the individual private key.

The transceiving unit 143 receives the individual private key pieces from the individual private key pieces generation unit 142 and shares some of the received individual private key pieces with other MPC servers, i.e., the second MPC server 150 and the third MPC server 160. On the other hand, when some of the individual private key pieces of the individual private key pieces generation unit 142 are shared with other MPC servers by using a zero-knowledge proof method, it may be confirmed whether some of the shared individual private key pieces are justified.

In addition, the transceiving unit 43 may generate a first computation result value via a separate computation process for the individual distribution key generated by the individual distribution key generation unit 144, and share the generated first computation result value with other MPC servers. On the other hand, when the first computation result value of the individual distribution key generation unit 144 is shared with other MPC servers by using the zero-knowledge proof method, it may be confirmed whether the shared first computation result value is justified.

The zero-knowledge proof is an encryption system in which a prover may prove that the prover knows information to a verifier which is an opponent without disclosing secret information thereof.

The individual distribution key generation unit 144 generate the individual distribution key corresponding to the user by using some of individual private key pieces shared with one or more other users and some of the plurality generated individual private key pieces.

Referring back to FIG. 2, an individual private key corresponding to a first user of the first client 110 may be set to the individual private key A, an individual private key corresponding to a second user of the second client 120 may be set to the individual private key B, and an individual private key corresponding to a third user of the third client 130 may be set to the individual private key C.

As an exemplary embodiment, the individual distribution key A corresponding to the first user may be generated by using A-1, B-1, and C-1 which are first pieces of the respective individual private keys A, B, and C, the individual distribution key B corresponding to the second user may be generated by using A-2, B-2, and C-2 which are second pieces of the respective individual private keys A, B, and C, and the individual distribution key C corresponding to the third user may be generated by using A-3, B-3, and C-3 which are third pieces of the respective individual private keys A, B, and C.

Therefore, since the A-1 piece among the individual private key pieces corresponding to the first user of the first client 110 is not shared with the second user and the third user, and A-2 or A-3 is shared with the second user and the third user by non-dialog type zero-knowledge proof, all of the individual private key pieces are not exposed.

The common public key generation unit 146 generates the common public key based on the individual distribution keys of one or more other users and the individual distribution key of the user.

It is preferable that the individual distribution key A, the individual distribution key B, and the individual distribution key C generate the first computation result value, the second computation result value, and the third computation result value via a separate computation process in the respective MPC servers, and are shared among the first MPC server 140, the second MPC server 150, and the third MPC server 160 by using the zero-knowledge proof method.

The storage unit 145 stores the generated individual distribution keys and common public key. The individual distribution key is preferably encrypted and stored in the storage unit 145, and when the individual distribution key is used upon signing, the individual distribution key may be decrypted and used.

It is preferable that an encryption value which the user inputs through the first client 110 or personal biological information of the user is used for encrypting the individual distribution key. When the individual distribution key is encrypted by using the input encryption value or the personal biological information of the user, it may be guaranteed that the user should participate in real time, and even though all servers are hacked, an asset may be safely protected if the user is not involved.

Since each individual distribution key is encrypted and stored in each MPC server, an accident does not occur even though all of the respective individual distribution key are exposed.

The storage unit 145 may be a hardware security module which is a physical computing device specially manufactured for safe key storage and encryption processing, and is not limited thereto.

FIG. 2 is a diagram schematically illustrating a process of generating a common public key by sculpting individual private keys in a multi-party computation based digital signature method according to an exemplary embodiment of the present invention.

The first MPC server 140, the second MPC server 150, and the third MPC server 160 generate the individual private keys A, B, and C corresponding to the users of the first client 110, the second client 120, and the third client 130.

The respective individual private keys A, B, and C are broken to pieces through a Shamir secret guarantee sharing algorithm, and the individual private key pieces corresponding to other users are shared among the first MPC server 140, the second MPC server 150, and the third MPC server 160. The zero-knowledge proof method may be used upon the sharing.

In FIG. 2, it may be confirmed that the individual private key A is broken to pieces into A-1, A-2, and A-3, the individual private key B is broken to pieces into B-1, B-2, and B-3, and the individual private key C is broken to pieces into C-1, C-2, and C-3.

It is preferable that the individual private key piece corresponding to the user is not shared, but the remaining individual private key pieces are shared with other users upon the sharing. Further, it is preferable that when the individual private key piece is shared, the individual private key piece is shared through the non-dialog type zero-knowledge proof.

The first MPC server 140, the second MPC server 150, and the third MPC server 160 combine the individual private key pieces shared thereby and store the combined individual private key pieces as the individual distribution keys. That is, the first MPC server 140 stores the pieces A-1, B-1, and C-1, the second MPC server 150 stores the pieces A-2, B-2, and C-2, and the third MPC server 160 stores the pieces A-3, B-3, and C-3, as the individual distribution keys.

Meanwhile, the common public key is generated and stored by using the respective individual distribution keys. The stored common public key may be used for verifying a joint signature value used upon the signing.

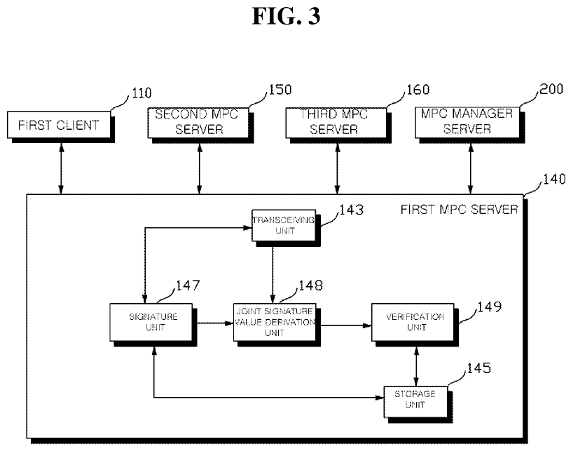

FIG. 3 is an overall system configuration diagram including a multi-party computation based digital signature apparatus according to another exemplary embodiment of the present invention.

Referring to FIG. 3, an entire system including the multi-party computation based digital signature apparatus is configured to include a first client 110, a first MPC server 140, a second MPC server 150, a third MPC server 160, and an MPC manager server 200.

The first MPC server 140 includes a transceiving unit 143, a storage unit 145, a signature unit 147, a joint signature value derivation unit 148, and a verification unit 149.

The signature unit 147 is requested with a transaction signature from the MPC manager server 200 through the transceiving unit 143, and decrypts, and then signs the individual distribution key encrypted and stored in the storage unit 145.

The joint signature value derivation unit 148 combines a signature value signed with the individual distribution key in the signature unit 147 and a signature value shared by the second MPC server 150 and the third MPC server 160 to derive the joint signature value.

The verification unit 149 verifies the derived joint signature value by using the common public key stored in the storage unit 145 to confirm the validity of the transaction.

As an exemplary embodiment of the signature, three MPC servers, i.e., the first MPC server 140, the second MPC server 150, and the third MPC server 160 participate in generating the common public key, and when the signature is made by two or more MPC servers, the transaction may be recognized as the valid transaction.

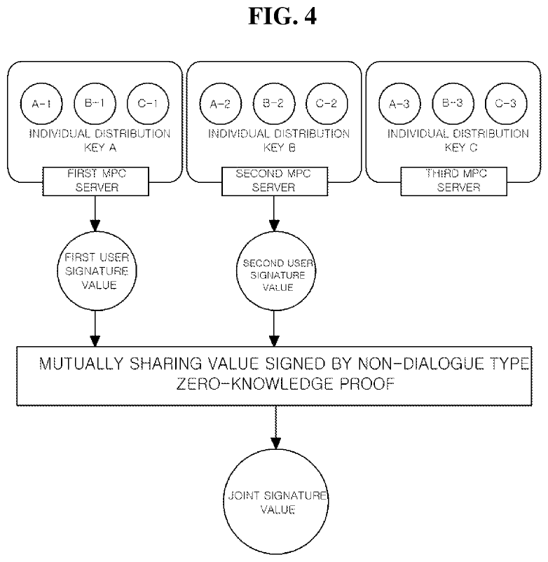

FIG. 4 is a diagram schematically illustrating a process of signing using individual distributed keys according to another exemplary embodiment of the present invention.

Referring to FIG. 4, in order to participate in the signature by using MPC servers of a predetermined threshold or more, each MPC server conducts the signature for the corresponding transaction with the individual distribution key which is already stored.

The first MPC server 140 generates a first user signature value by using the individual distribution key A and the second MPC server 150 generates a second user signature value by using the individual distribution key B. When the predetermined threshold is 2, the signature may be made even if the third MPC server 160 does not participate in the signature.

In a state in which the individual distribution key for each MPC server of the transaction is not opened by the non-dialog type zero-knowledge proof, the second MPC server 150 knows whether the signature of the first MPC server 140 sending the first user signature value is justified, and the first MPC server 140 knows whether the signature of the second MPC server 150 sending the second user signature value is justified.

Each of the first MPC server 140 and the second MPC server 150 derives the joint signature value by using the signature value shared with each other.

By verifying the derived joint signature value by using the common public key derived when generating the individual distribution key, the validity of the signed transaction may be confirmed.

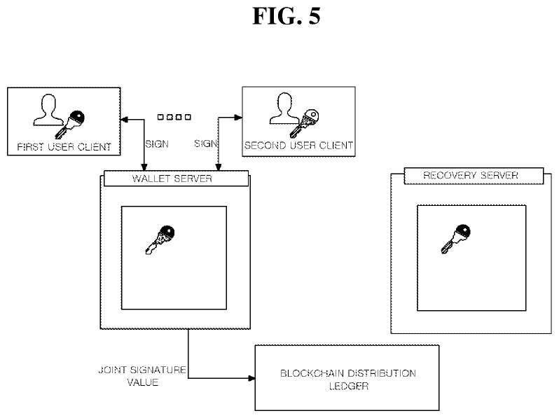

FIG. 5 illustrates a process of signing using an individual distributed key stored for each user according to another exemplary embodiment of the present invention.

Referring to FIG. 5, a first user client, a second user client, a wallet server, and a recovery server store individual distribution keys, respectively.

The first user client, the second user client, and the wallet server may correspond to the first MPC server 140, the second MPC server 150, and the third MPC server 160 of FIG. 1, respectively.

In this case, private keys generated in the first MPC server 140, the second MPC server 150, and the third MPC server 160, respectively may be generated as follows.

For example, the first user client may possess pieces a and c among individual distribution keys constituted by a, b, and c, the second user client may possess pieces b and c, and the wallet server may possess pieces a and b.

In this case, even though the individual distribution keys are leaked from any one subject of the first user client, the second user client, and the wallet server, all individual distribution keys may not be known, so another multi-party computation based digital signature apparatus should be involved in all transactions.

Meanwhile, since the common public key may not be known even though the individual distribution keys a and b are leaked, an internal accident of the multi-party computation based digital signature apparatus may also be prevented.

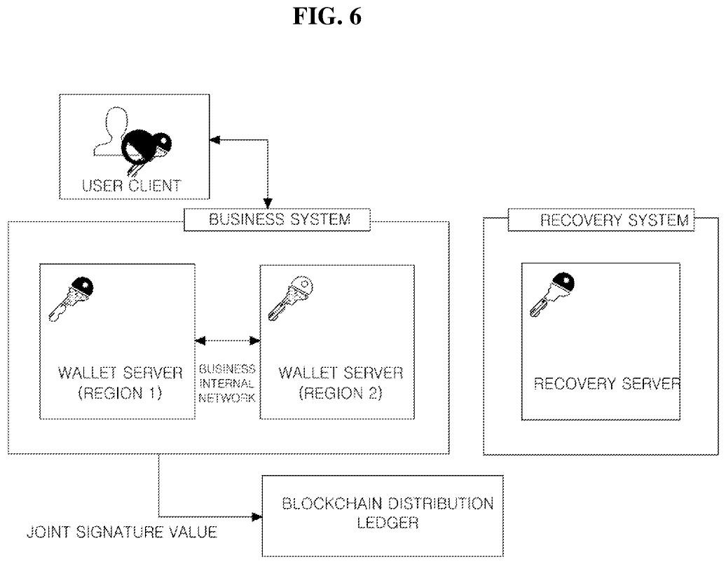

FIG. 6 illustrates a state in which a user does not have one private key, and the private key is divided into several individual distributed keys and distributed to a plurality of wallet servers included in a business system according to still another exemplary embodiment of the present invention.

Referring to FIG. 6, a user client does not store one private key, and the private key is divided into several individual distribution keys, and the respective individual distribution keys are distributed and stored in a wallet server (region 1) and a wallet server (region 2) of the business system.

Even though the individual distribution key is leaked from any one wallet server of the wallet servers included in the business server, if the individual distribution key stored in the other wallet server is not leaked, an account may maintain a safe state.

Meanwhile, the user client, the wallet server (region 1), and the wallet server (region 2) may correspond to the first client 110, the first MPC server 140, and the second MPC server 150 of FIG. 1, respectively.

Similarly, to the first client 110 of FIG. 1, the user client of FIG. 6 does not also store the private key, and the wallet server (region 1) and the wallet server (region 2) may generate the individual distribution keys as follows.

For example, when the wallet server (region 1) possesses the pieces a and b of the individual distribution key and the wallet server (region 2) possesses the pieces b and c of the individual distribution key, the transaction may not be generated even though the individual distribution key piece is leaked from any one wallet server of the wallet servers (region 1 and region 2).

Meanwhile, the recovery server possesses the pieces a and c of the individual distribution key, and even though the individual distribution key piece of any one of the wallet servers is lost or deleted, the lost or deleted individual distribution key pieces may be recovered or newly generated with individual distribution key pieces possessed by other wallet servers and the recovery server.

For example, when the individual distribution key pieces a and b of the wallet server (region 1) are deleted, the individual distribution key pieces a and b of the wallet server (region 1) may be recovered by using the individual distribution key pieces a and c possessed by the recovery server and the individual distribution key pieces b and c possessed by the wallet server (region 2).

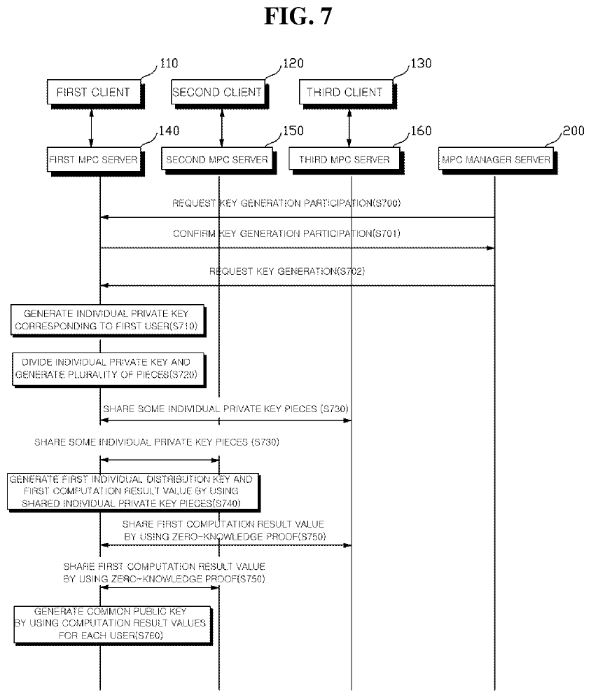

FIG. 7 is a flowchart of a multi-party computation based digital signature method according to an exemplary embodiment of the present invention.

Referring to FIG. 7, the multi-party computation based digital signature method according to the exemplary embodiment is constituted by steps processed in time series by the multi-party computation based digital signature apparatus illustrated in FIGS. 1 and 3. Therefore, hereinafter, even though contents are omitted, contents described above in regard to the multi-party computation based digital signature apparatus illustrated in FIGS. 1 and 3 are also applied to the multi-party computation based digital signature method according to the exemplary embodiment.

In step 700, as an exemplary embodiment of the multi-party computation based digital signature apparatus, the first MPC server 140 receives a key generation participation request from the MPC manager server 200. Similarly to the first MPC server 140, the second MPC server 150 and the third MPC server 160 also receive the key generation participation request from the MPC manager server 200. In FIG. 7, three MPC servers are illustrated, but the MPC servers may be constituted by a plurality of servers, e.g., two or more servers.

In step 701, the first MPC server 140, the second MPC server 150, and the third MPC server 160 transmit a key generation participation confirmation to the MPC manager server 200. By transmitting the key generation participation confirmation, each of the MPC servers 140, 150, and 160 participates in generating the individual distribution key and the common public key.

In step 702, the first MPC server 140, the second MPC server 150, and the third MPC server 160 receives a request for generating the key from the MPC manager server 200. When receiving the key generation request, each of the MPC servers 140, 150, and 160 performs each of steps S710 to 760. Hereinafter, the method is described based on the first MPC server 140, but other MPC servers 150 and 160 also perform the same method.

In step 710, the first MPC server 140 generates the individual private key A corresponding to the first user. The individual private key A may be a random value generated in the first MPC server 140.

In step 720, the first MPC server 140 divides the generated individual private key to generate a plurality of pieces. It is preferable that the number of pieces acquired by dividing the individual private key is at least two, and the number of pieces is equal to the number of users involved in the transaction.

In step 730, the first MPC server 140 may share some of the generated individual private key pieces with other MPC servers, i.e., the second MPC server 150 and the third MPC server 160. The first MPC server 140, the second MPC server 150, and the third MPC server 160 may directly share some of the individual private key pieces with each other, and share some individual private key pieces through the MPC manager server 200.

The individual private key piece may be encrypted and delivered with an individual public key corresponding to an individual private key of an opponent which is to share the individual private key piece. When the shared encrypted individual private key piece of the opponent is decrypted with the individual private key, the decrypted individual private key piece may become individual private key piece data which are divided as they are.

For example, the pieces of the individual private key A of the first MPC server are divided into three pieces, i.e., A-1, A-2, and A-3, A-1 as private key pieces used for generating the individual distribution key of the first MPC server need not be transmitted to other MPC servers 150 and 160, and the pieces A-2 and A-3 are preferably transmitted to other MPC servers. The piece A-1 of the private key A is not transmitted to the outside of the first MPC server 140 through such a method, so an intact private key A is unknown except for the first MPC server 140. Therefore, the piece of the individual private key corresponding to the first MPC server 140 is not included upon the transmission, and may be included when only the private key pieces corresponding to other MPC servers are transmitted, and other MPC servers may also transmit the individual private key pieces by a similar method.

In step 740, the first MPC server 140 generates a first individual distribution key by using the private key pieces shared in step 730. It is preferable that the generated first individual distribution key generates the first computation result value via a separate computation process. A method of computing a result value by using the first individual distribution key may use a separate encryption function.

In the example, the first MPC server 140 may receive a piece B-1 from the second MPC server 150 and receive a piece C-1 from the third MPC server 160, and generate the first individual distribution key jointly with the piece A-1 which the first MPC server 140 already has. It is preferable that the generated first individual distribution key is encrypted, and stored in the storage unit 145.

A function of encrypting the individual distribution key may use information such as personal biological information, an ID/password, etc., as the encryption key. In this case, it is preferable that the encryption key is not stored. The individual distribution key is encrypted by using the function of encrypting the individual distribution key, so the transaction is not made if the user is not involved even though all MPC servers are hacked.

In step 750, the first MPC server 140 may share a result value (the first computation result value) computed by using the generated first individual distribution key with other MPC servers, i.e., the second MPC server 150 and the third MPC server 160. A method of computing a computation result value by using the first individual distribution key may use a separate encryption function. The first MPC server 140 shares the first computation result value with other MPC servers by using the zero-knowledge proof method, so other MPC servers may confirm whether the shared first computation result value is justified.

In step 760, the first MPC server 140 generates the common public key by using the result value (the first computation result value) computed by using the first individual distribution key, a result value (the second computation result value) computed by using the second individual distribution key shared by other MPC servers, and a result value (the third computation result value) computed by using the third individual distribution key. In the computation as a computation using any function, it is preferable that all MPC servers use the same function.

As an exemplary embodiment, it is preferable that the first MPC server 140 generates the common public key by using a homogeneous encryption result value output through a homogeneous encryption task with respect to each of the first individual distribution key, the second individual distribution key, and the third individual distribution key.

Since the respective MPC servers 140, 150, and 160 do not share the respective individual distribution keys, but share the computation result value computed by using the individual distribution key, the individual distribution key is not exposed to the outside.

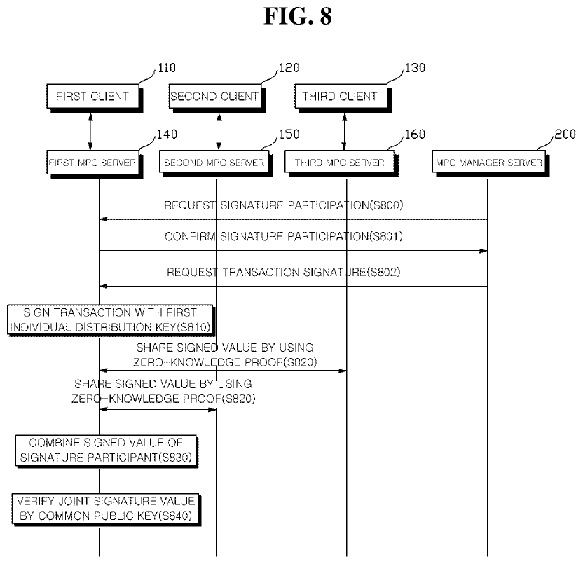

FIG. 8 is a flowchart of a method of signing by using a common public key generated by a multi-party based digital signature encryption method according to an exemplary embodiment of the present invention.

In step 800, the first MPC server 140 is requested with participating in the signature from the MPC manager server 200.

In step 801, the first MPC server 140 transmits a signature participation confirmation from the MPC manager server 200.

In step 802, the first MPC server 140 is requested with signing the transaction from the MPC manager server 200.

In step 810, the first MPC server 140 signs the transaction by using the first individual distribution key generated in step 740. It is preferable that the first individual distribution key is encrypted and stored in the storage unit 145, and the encrypted first individual distribution key is decrypted, and then the transaction is signed.

In step 820, the first MPC server 140 shares a value signed with the first individual distribution key by using the value signed with each individual distribution key in each of other MPC servers 150 and 160, and the zero-knowledge proof method. By using the zero-knowledge proof method, it is proved that the signed value is signed by the individual distribution key in the state in which the individual distribution key is not opened.

In step 830, the first MPC server 140 combines the shared sign values to derive the joint signature value.

In step 840, the first MPC server 140 regards the derived joint signature value as a digital signature and verifies the derived joint signature value by using the common public key stored in the storage unit 145 to confirm whether the generated digital signature is a right digital signature. It is possible that another MPC server which participates in the signature also verifies the joint signature value.

According to the exemplary embodiment of the present invention, since the private key corresponding to the common public key does not substantially exist, and the signature is made by using the individual distribution key, there is an advantage in that there is no concern about the leakage of the private key.

Step 840 of FIG. 8 is made in each of the MPC servers 140, 150, and 160, but the common public key is an opened key, so verification is also possible in a place where the transaction is requested.

A digital signature task performed by the decrypted individual distribution key A of the first MPC server 140 may be expressed as sA(Tx), a digital signature task performed by the decrypted individual distribution key B of the second MPC server 150 may be expressed as sB(Tx), a digital signature task performed by the decrypted individual distribution key C of the third MPC server 160 may be expressed as sC(Tx), and when the digital signature tasks of all individual distribution keys are combined, the digital signature task may be expressed as sABC(Tx). The sABC(Tx) is commonly signed, and used.

Meanwhile, for back-up or cold storage, a fourth MPC server (not illustrated) may be additionally provided. Therefore, the fourth MPC server is preferably a terminal of an institution having guaranteed reliability, such as Financial Security Agency.

When three respective servers, i.e., the first MPC server 140, the second MPC server 150, and the third MPC server 160 generate the individual distribution keys, and the valid signature is made in at least two MPC servers, a right transaction is assumed, and in this case, when the fourth MPC server signs jointly with any one MPC server of the first MPC server 140, the second MPC server 150, and the third MPC server 160, the valid transaction is generated, so the fourth MPC server serves as the MPC server for the backup.

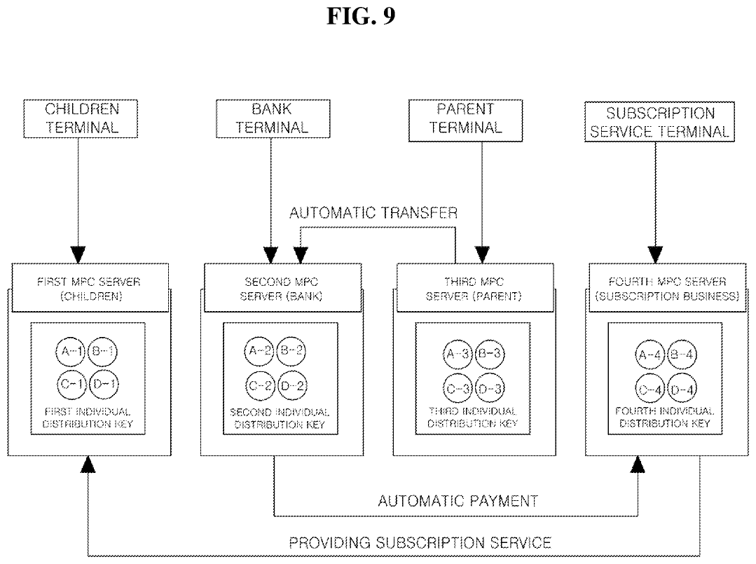

FIG. 9 is a conceptual view of a financial transaction system using a multi-party computation based digital signature apparatus according to an exemplary embodiment of the present invention.

The financial transaction system using the multi-party computation based digital signature apparatus according to the exemplary embodiment of the present invention may conclude the transaction by using beneficiaries, contractors, banks, and service providers using the individual distributed keys thereto.

Referring to FIG. 9, as a user terminal which participates in generating the individual distribution key, a children terminal (beneficiary), a bank terminal, a parent terminal (contractor), and a subscription service terminal are illustrated.

The children terminal, the bank terminal, the parent terminal, and the subscription service terminal generate and store the individual distribution key of each user through the first MPC server, the second MPC server, the third MPC server, and the fourth MPC server, respectively.

A child, a bank officer, a parent, and a subscription business may generate the individual distribution key and the common public key via the process illustrated in FIG. 7 through the children terminal (beneficiary), the bank terminal, the parent terminal (contractor), and the subscription service terminal, respectively, and sign and verify the joint signature value via the process illustrated FIG. 8.

The parent decrypts the third individual distribution key stored in the third MPC server through the parent terminal, and then signs an automatic transfer transaction. Meanwhile, the bank officer decrypts the second individual distribution key stored in the second MPC server through the bank terminal, and then signs the automatic transfer transaction.

Thereafter, the second MPC server and the third MPC server combine the signature value signed by the second individual distribution key and the signature value signed by the third individual distribution key to verify the combined signature value with the common public key. When the verification of the combined signature value is completed by the second MPC server and the third MPC server, an automatic transfer is made from a parent account of the bank to a bank account of the subscription business.

Meanwhile, when an automatic payment transaction from the bank account of the parent to the bank account of the subscription business is additionally required for the automatic transfer transaction, the signature of the subscription business may be required.

In this case, the second MPC server and the fourth MPC server sign by using the second individual distribution key and the fourth individual distribution key, respectively, and combine the signed values, and then verify the combined signature value with the common public key to complete the automatic payment transaction.

As another exemplary embodiment, the second MPC server, the third MPC server, and the fourth MPC server sign by using the second individual distribution key, the third individual distribution key, and the fourth individual distribution key, respectively, and combine the signed values, and then verify the combined signature value with the common public key to complete both the automatic transfer transaction and the automatic payment transaction.

When the subscription business additionally requires the signature with the individual distribution key of the first MPC server in order to provide the subscription service to the child, the first MPC server and the fourth MPC server sign by using the first individual distribution key and the fourth individual distribution key, respectively, and combine the signed values, and then verify the combined signature value with the common public key to complete a transaction of providing the subscription service to the child.

For example, it is possible that a specific condition, i.e., $1,000 per month is set to be automatically transferred between the second MPC server corresponding to the bank and the third MPC server corresponding to the parent, or $100 per year is set to be automatically paid between the third MPC server corresponding the parent and the fourth MPC server corresponding to the subscription service business.

The financial transaction system using the multi-party computation based digital signature apparatus according to the exemplary embodiment of the present invention can perform a financial transaction with another user as a beneficiary only with signatures of some users without a need for participation of all users in order to a financial transaction between a plurality of users.

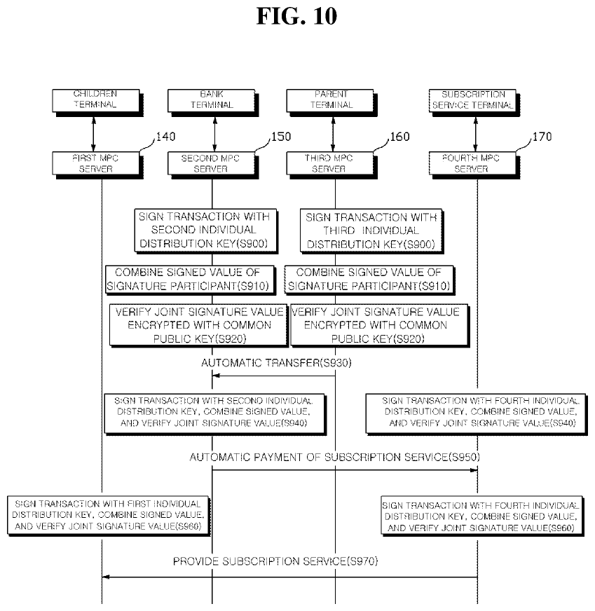

FIG. 10 is a flowchart of a financial transaction method using a multi-party computation based digital signature method according to an exemplary embodiment of the present invention.

In step 900, the second MPC server 150 signs the automatic transfer transaction with the second individual distribution key, and the third MPC server 160 signs the automatic transfer transaction with the third individual distribution key.

In step 910, the second MPC server 150 and the third MPC server 160 share and combine the signed values by using the zero-knowledge proof, so each of the second MPC server 150 and the third MPC server 160 generates the joint signature value.

In step 920, Each of the second MPC server 150 and the third MPC server 160 verifies the joint signature value with the common public key to effectively set the automatic transfer transaction.

In step 930, the automatic transfer transaction is made in a bank account of the parent.

In step 940, the automatic payment transaction is made between the bank and the subscription business.

In step 940, the second MPC server 150 and the fourth MPC server 170 signs the automatic payment transaction with the second individual distribution key and the fourth individual distribution key, respectively, and combine the signed values, and then verify the joint signature value, and as a result, steps 900 to 920 are made between the second MPC server 150 and the fourth MPC server 170.

When the joint signature value is verified in step 940, the automatic payment is made from the parent bank account to the subscription service business account in step 950.

A subscription service providing transaction is made between the child and the subscription business in step 960. Similarly to step 940, in step 960, the first MPC server 140 and the fourth MPC server 170 sign the subscription service providing transaction, and combine the signed values, and then verify the joint signature value. In step 960, when the joint signature value is verified, the subscription service is provided to the children terminal.

As described above, when the transaction is required between some users among the plurality of users who participate in generating the individual distribution key or the common public key, only a person directly connected to the transaction signs, which may easily cause the transaction.

The operations according to the exemplary embodiments of the present invention are implemented in a form of a program command which may be performed through various computer means and may be recorded in the computer readable medium. The computer readable medium may include a program command, a data file, a data structure, etc., singly or combinationally. The program command recorded in the medium may be specially designed and configured for the present invention, or may be publicly known to and used by those skilled in the computer software field. An example of the computer readable recording medium includes magnetic media, such as a hard disk, a floppy disk, and a magnetic tape, optical media such as a CD-ROM and a DVD, magneto-optical media such as a floptical disk, and hardware devices such as a ROM, a RAM, and a flash memory, which are specially configured to store and execute the program command. An example of the program command includes a high-level language code executable by a computer by using an interpreter and the like, as well as a machine language code created by a compiler. The hardware device may be configured to be operated with one or more software modules in order to perform the operation of the present invention and vice versa.

The term ‘unit’ used in the exemplary embodiment means software or a hardware component such as field-programmable gate array (FPGA) or ASIC, and ‘unit’ performs some roles. However, the “unit” is not a meaning limited to software or hardware. The “unit” may be configured to reside on an addressable storage medium and may be configured to play back one or more processors. Accordingly, as one example, the “unit” includes components such as software components, object oriented software components, class components, and task components, processes, functions, attributes, procedures, subroutines, segments of a program code, drivers, firmware, microcode, circuitry, data, databases, data structures, tables, arrays, and variables. Functions provided in the components and the “units” may be combined into a smaller number of components and “units” or further separated into additional components and “units”. In addition, the components and ‘unit’s may be implemented to play one or more CPUs in the device or security multimedia card.

All of the functions described above may be performed by processors such as a microprocessor, a controller, a micro controller, or an application specific integrated circuit (ASIC) according to software or a program code coded to perform the above functions. The design, development, and implementation of the code will be apparent to those skilled in the art based on the description of the present invention.

As described above, the present invention has been described by specified matters such as detailed components, and the like and limited exemplary embodiments and drawings, but the description is just provided to assist more overall understanding of the present invention and the present invention is not limited to the exemplary embodiment and various modifications and changes can be made by those skilled in the art from such a disclosure.

Accordingly, the spirit of the present invention should not be defined only by the described exemplary embodiments, and it should be appreciated that claims to be described below and all things which are equivalent to the claims or equivalently modified to the claims are included in the scope of the spirit of the present invention.

What is claimed is:

1. A financial transaction system using individual distribution keys based on multi-party computation, comprising:
a private key pieces generation unit dividing an individual private key corresponding to a user and generating a plurality of private key pieces;
an individual distribution key generation unit generating the individual distribution key corresponding to the user by using some of individual private key pieces shared with one or more other users and some of the plurality generated individual private key pieces; and
a signature unit signing with the individual distribution key of the user,
wherein when a verification is performed by combining a signature value signed by the individual distribution key of the user and a signature value signed by individual distribution keys of one or more other users, the transaction is concluded between the users who sign.

2. The financial transaction system of claim 1, wherein a user who participates in generating the individual distribution key, and does not participate in signing the transaction among the one or more other users is designated as a beneficiary of the transaction.

3. The financial transaction system of claim 1, further comprising:
a common public key generation unit generating a common public key based on the individual distribution keys of the one or more other users and the individual distribution key of the user; and
a joint signature value derivation unit combining the signature value signed with the individual distribution key of the user and the signature value shared of the one or more other users to derive a joint signature value,
wherein the derived joint signature value is verified by using the common public key to confirm of the validity of the transaction.

4. A financial transaction method using individual distribution keys based on multi-party computation, comprising:
dividing an individual private key corresponding to a user and generating a plurality of private key pieces;
generating the individual distribution key corresponding to the user by using some of individual private key pieces shared with one or more other users and some of the plurality generated individual private key pieces; and
signing with the individual distribution key of the user,
wherein when a verification is performed by combining a signature value signed by the individual distribution key of the user and a signature value signed by individual distribution keys of one or more other users, the transaction is concluded between the users who sign.

5. The financial transaction method of claim 4, wherein a user who participates in generating the individual distribution key, and does not participate in signing the transaction among the one or more other users is designated as a beneficiary of the transaction.

6. The financial transaction method of claim 4, further comprising:
generating a common public key based on the individual distribution keys of the one or more other users and the individual distribution key of the user; and
combining the signature value signed with the individual distribution key of the user and the signature value shared of the one or more other users to derive a joint signature value,
wherein the derived joint signature value is verified by using the common public key to confirm of the validity of the transaction.

7. A computer-readable recording medium having a program for executing a method of claim 4 in a computer, which is recorded therein.
